(19) United States
(12) Patent Application Publication
(10) Pub. No.: US 2003/0138105 A1
(43) Pub. Date: Jul. 24, 2003

(54) Storing keys in a cryptology device

(75) Inventors: David Carroll Challener, Raleigh, NC (US); Scott Thomas Elliott, Raleigh, NC (US); James Patrick Hoff, Raleigh, NC (US); James Peter Ward, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/051,495

(22) Filed: Jan. 18, 2002

(51) Int. Cl. H04L 9/00

(52) U.S. Cl. 380/277

(57) ABSTRACT

A method and system for managing cryptology keys in a TCPA subsystem such as a Trusted Platform Module (TPM). The TPM encrypts/decrypts data being communicated with a processing system. Internal to the TPM is limited memory for storing cryptology private keys used in the encryption/decryption. Under the TCPA specification, the keys are hierarchical, such that a parent key must be in the TPM to load into the TPM the requested child cryptology private key. Thus there is an expense associated with replacing an existing key. This expense is determined by the probability that the evicted key will be needed and thus re-stored in the future and the likelihood that ancestor keys will have to be loaded into the TPM in order to load the requested child key. The present invention presents a method for determining this expense, in order to determine which key should be evicted.

### BACKGROUND OF THE INVENTION

1. Technical Field

The present invention relates in general to the field of computers, and, in particular, to encryption and decryption of data communicated between computers. Still more particularly, the present invention relates to an improved method and system for determining which cryptology key previously stored in a local memory of a cryptology device is replaced when a new cryptology key is loaded.

2. Description of the Related Art

Personal computers and computer networks, including the Internet, are designed to be open and flexible for ease of access to users. However, this openness presents security problems when confidential communication between computers is desired, such as when transmitting messages containing financial information, business secrets, personal information, etc. To provide security for communications between two computers in such a network, messages are often encrypted. Encryption typically is performed using a cryptology key (“key”), which is a cipher having a pre-determined value, that is applied using an algorithm to a string or block of unencrypted data to produce encrypted data, or to decrypt encrypted data. Encryption that uses the same key to encrypt and decrypt a message is known as symmetric-key cryptography. Symmetric-key cryptography systems are simple and fast, but their main drawback is that the two parties must somehow exchange the key in a secure way. A second type of encryption, asymmetric encryption, avoids this problem by using two keys: a public key and a private key. The public key is available to anyone to encode a message to be sent to a receiving user. The private key is available only to the receiving user to decrypt the message. Alternatively, the private key may be used to encrypt the message and the public key may be used to decrypt the message. A popular method using asymmetric encryption is known as a Public Key Infrastructure (PKI).

PKI consists of a certificate authority (CA) that issues and verifies to the users a digital certificate, which includes the public key. The CA simultaneously creates the public key and the private key. The public key is made publicly available as part of the digital certificate in a directory that all parties can access, while the private key is given only to the requesting party. Typically, the public key is used to encrypt data, and the private key is used to decrypt the data. A popular algorithm used in encryption and authentication systems using public and private keys is RSA, named in 1977 for its inventors Ron Rivest, Adi Shamir and Leonard Adleman. RSA uses two large random prime numbers that are multiplied together and manipulated with modulus arithmetic such that the receiver holding the private key can decrypt any message from any party that has been encrypted with the public key. Other popular cryptographic algorithms include those based on a Secure Hash Algorithm (SHA), an Advanced Encryption Standard (AES) used by U. S. Government organizations, a Data Encryption Standard (DES) and Hashing Message Authenticating Code (HMAC).

In response to a need to enhance the security of computer systems, the industry working group Trusted Computing Platform Alliance (TCPA) was formed in October 1999 by Compaq Computers, Inc. (Compaq), Hewlitt-Packard Corporation (HP), International Business Machines Inc. (IBM), Intel Inc. and Microsoft Inc. The TCPA has established standards for embedding security functionality in computer systems. TCPA Main Specification Version 1.1 is a standard defining how a computer system can utilize asymmetric encryption by creating its own public/private key pairs in a TCPA subsystem of the computer system, in a manner analogous to that of a CA in a PKI. The TCPA subsystem, typically using a hardware chip called a Trusted Platform Module (TPM), uses cryptographic algorithms based on RSA, DES, SHA, HMAC and AES. However, managing and accessing these cryptographic key pairs, and in particular securely storing the private key of the pair in the TPM, is problematic due to a limited amount of memory in the TPM as specified by the TCPA.

### SUMMARY OF THE INVENTION

The present invention recognizes the need for a method and system to manage, store and access a requested cryptology private key in a Trusted Computer Platform Alliance (TCPA) subsystem such as a Trusted Platform Module (TPM), whose specifications are described in TCPA Main Specification Version 1.1 and TCPA PC Specific Implementation Specification, Version 1.00. The TPM encrypts/decrypts data being communicated with a processing system. Internal to the TPM is a limited amount of memory for storing cryptology private keys used in the encryption/decryption. Under the TCPA specification, the keys are hierarchical, such that a parent key must be in the TPM to load into the TPM the requested cryptology private key (child key of the parent key).

There is a potential expense associated with evicting an existing cryptology private key in order to replace it with a new private key. This expense is due to the need to re-store not only the evicted private key, but the expense of loading any ancestors of that evicted private key that are necessary to load the evicted private key. To calculate the true potential expense of evicting the private key from the TPM, the present invention determines both the probability that the evicted key will be needed in the future and thus re-stored in the TPM, plus the number of ancestor keys that will have to be loaded into the TPM in order to re-store the evicted private key. The present invention presents a method and system for determining this expense in order to determine which private key should be evicted.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram of a computer system having a Trusted Platform Module (TPM);

FIGS. 2a-2c depict the secure storage of private cryptology keys in a secondary storage;

FIG. 3 illustrates a private key in the TPM decoding an encoded message and sending the decoded message to an input/output (I/O);

FIGS. 4a-4d depict a process for loading a private key into the TPM to decode an encoded message when the necessary private key is not preloaded in the TPM;

FIGS. 5a-5d illustrate the loading of two generations of private keys when a first generation is not preloaded in the TPM;

FIG. 6 is a flow chart illustrating a loading of multiple private keys in the TPM; and

FIGS. 7a-7c depicts a hierarchal relationship of private keys in a Trusted Computer Platform Alliance (TCPA) scheme, and an impact on the TPM for evicting one of the private keys from the TPM.

### DETAILED DESCRIPTION OF THE PREFERRED EMBODIMENT

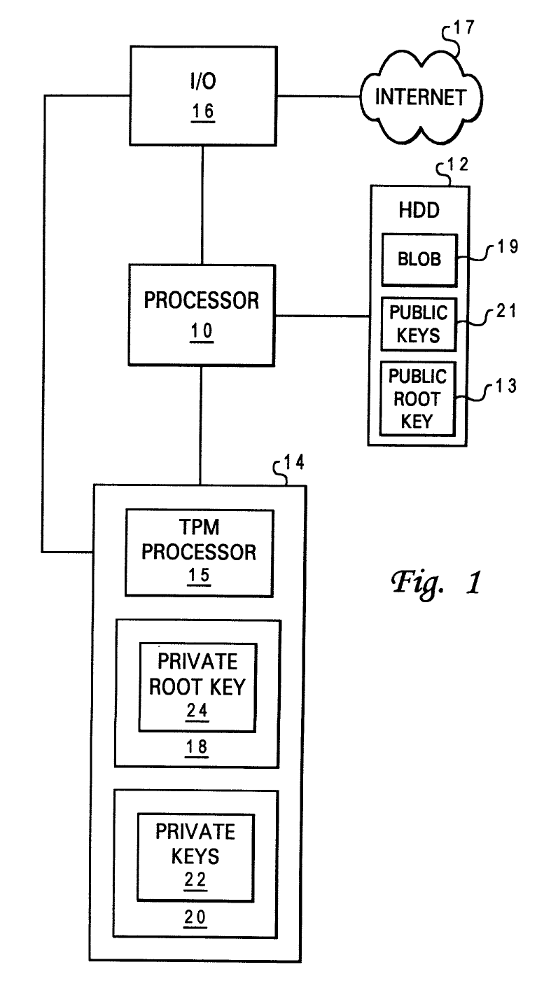

With reference now to the drawings and in particular to FIG. 1, there is depicted a block diagram of a computer system used in a preferred embodiment of the present invention. A processor 10 is attached to a storage device 12, which is preferably a hard disk drive (HDD) or alternatively any other type of mass data storage device. Also attached to processor 10 is a Trusted Platform Module (TPM) 14. TPM 14 is the hardware instantiation of a Trusted Computing Platform Alliance (TCPA) subsystem. The TCPA subsystem, whose specification is described in TCPA Main Specification Version 1.1 and TCPA PC Specific Implementation Specification, Version 1.00, which are incorporated herein by reference, includes TPM 14 and software to control the TCPA subsystem. Coupled to TPM 14 and processor 10 is an Input/Output (I/O) 16, a circuit capable of interfacing and communicating with other devices (not shown), typically through a computer network such as an Internet 17. Encrypted messages are communicated between I/O 16 and processor 10 via TPM 14, while those messages that are communicated without encryption are transmitted directly between I/O 16 and processor 10. TPM 14 includes a TPM processor 15, which is capable of encoding/decoding messages received from I/O 16, as well generating asymmetric pairs of public/private keys for cryptological use.

When TPM 14 is first implemented by processor 10, TPM processor 15 generates a private root key 24 and its corresponding public root key 13. Private root key 24 is stored only in TPM non-volatile memory (TPM NVM) 18, which in a preferred embodiment is an electrically erasable programmable read only memory (EEPROM) or other similar non-volatile memory (NVM), in which private root key 24 remains stored until changed by an authorized user. Public root key 13 is preferably stored in storage device 12.

TPM processor 15 is also able to generate subsequent private/public keys based on public root keys 13 and private root keys 24. These subsequent private/public keys are identified as TPM private key 22 and TPM public key 21. Each TPM private key 22 is initially stored in a volatile TPM Random Access Memory (TPM RAM) 20. To allow future access and use, each TPM private key 22 may be stored in a non-volatile memory, such as storage device 12, but only if first made secure. To accomplish this security, each of the TPM private keys 22 is first wrapped with encryption and header data, such as the user's password, by the TPM private key 22's parent key (discussed in further detail below) and stored on storage device 12 as a secure binary large object (“blob”) 19. TPM private key 22's counterpart TPM public key 21 is preferably stored in storage device 12. When located in TPM RAM 20, TPM private keys 22 are able to decode messages encoded with their corresponding TPM public key 21.

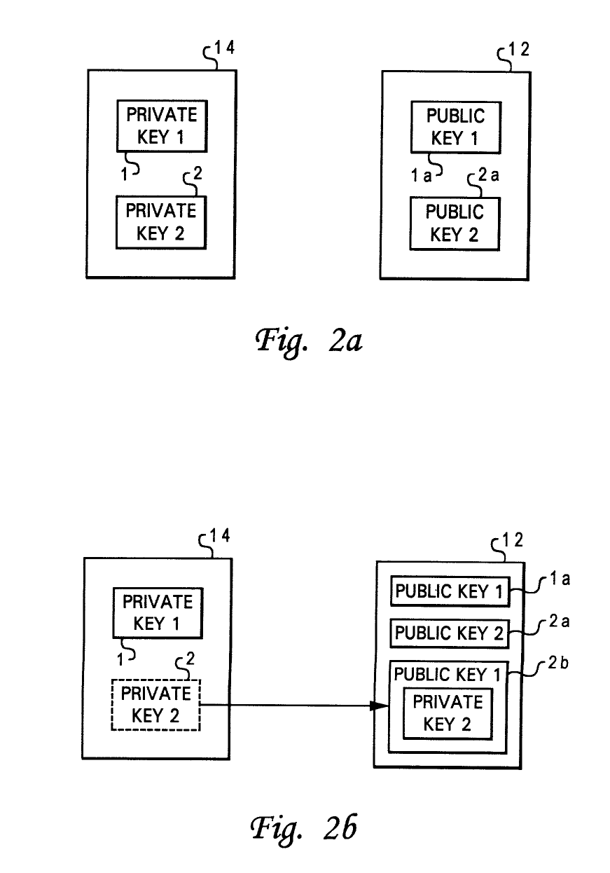

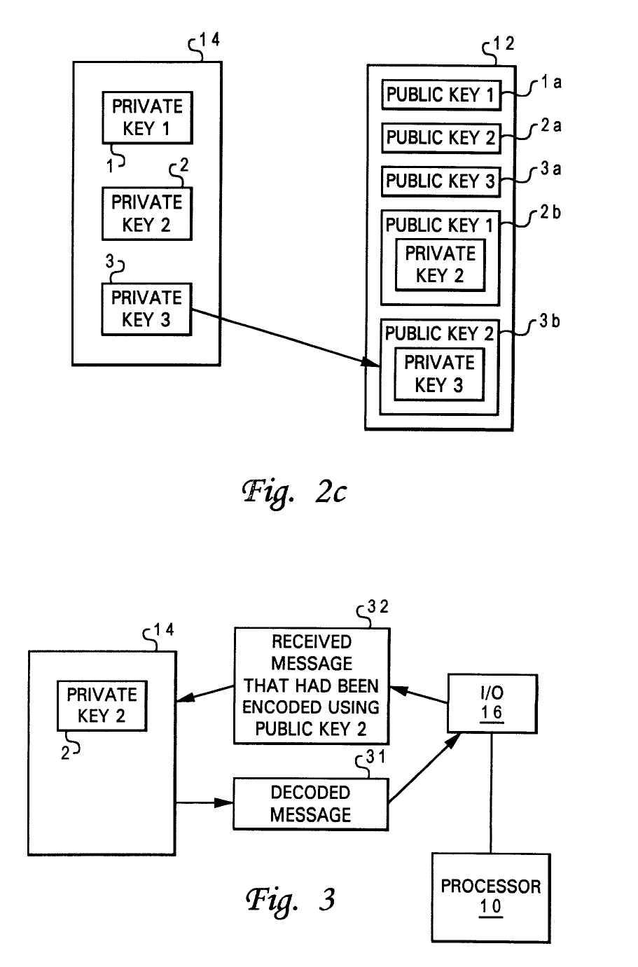

With reference now to FIGS. 2a-2c, there is depicted the sequence of events required to securely store private keys 22 in storage device 12. For the purpose of clarity, it will be assumed that depicted private key 1 is private root key 24 stored in TPM NVM 18, and private key 2 is a TPM private key 22 stored in TPM RAM 20 (as shown in FIG. 1). Likewise, it will be assumed that public key 1a and public key 2a are TPM public keys 21 (shown in FIG. 1). However, it is understood that alternatively private key 1 may be one of the TPM private keys 22 and public key la may be one of the TPM public keys 21 that correspond to one of the TPM private keys 22.

FIG. 2a depicts TPM 14 containing private key 1 and private key 2. Corresponding public keys 1a and 2a are shown stored in storage device 12, but public keys 1a and 2a may also be stored in a remote server or other remote storage location for better access to those wishing to use the public key to encrypt messages being sent to processor 10. Referring now to FIG. 2b, private key 2 is shown as being stored in storage device 12 in the form of blob 2b. Blob 2b includes private key 2 which has been wrapped with public key 1, and preferably other header data such as the user's password, to be secure and thus making private key 2 inaccessible to the public. Likewise, Figure 2c depicts private key 3 being moved to storage device 12 in the form of blob 3b, which is wrapped by public key 2. Note that there is no blob 1b, since private key 1 always remains within TPM NVM 18.

Referring now to FIG. 3, when an encoded message 32 reaches I/O 16, it is sent to TPM 14 for decoding. For example, assume that private key 2 is loaded in TPM 14 (in TPM RAM 20) as shown. When an encoded message 32, which was previously encoded by a sender using public key 2, is received at TPM 14 from I/O 16, private key 2 decodes the encoded message 32 into decoded message 31, and sends decoded message 31 back to I/O 16 for appropriate handling by processor 10.

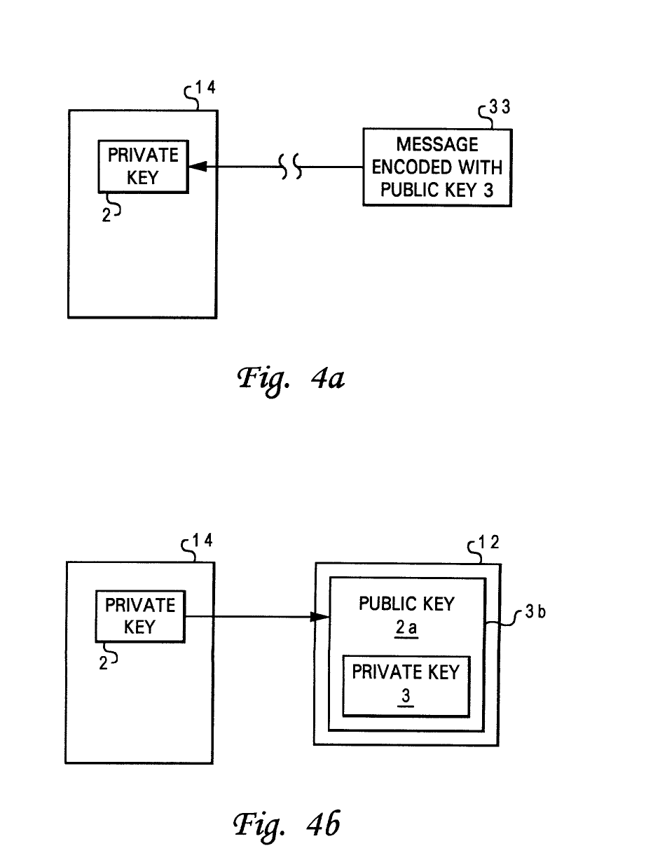

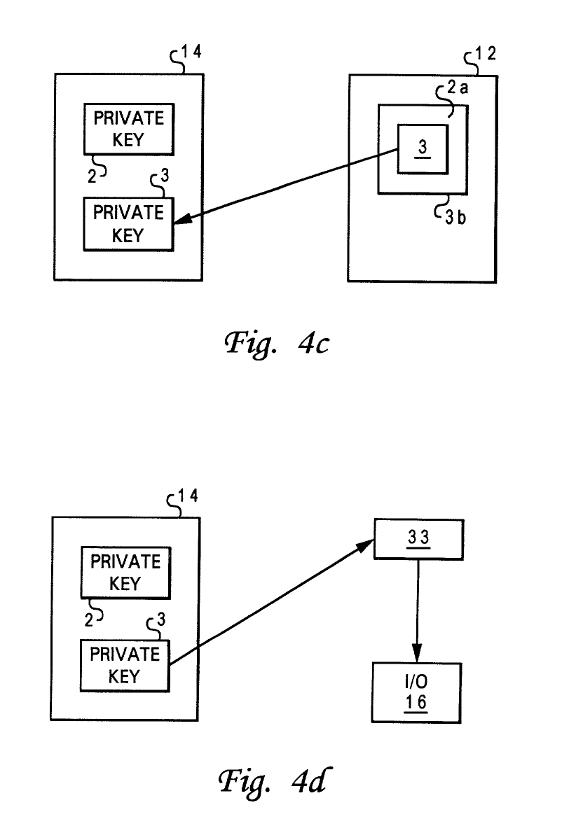

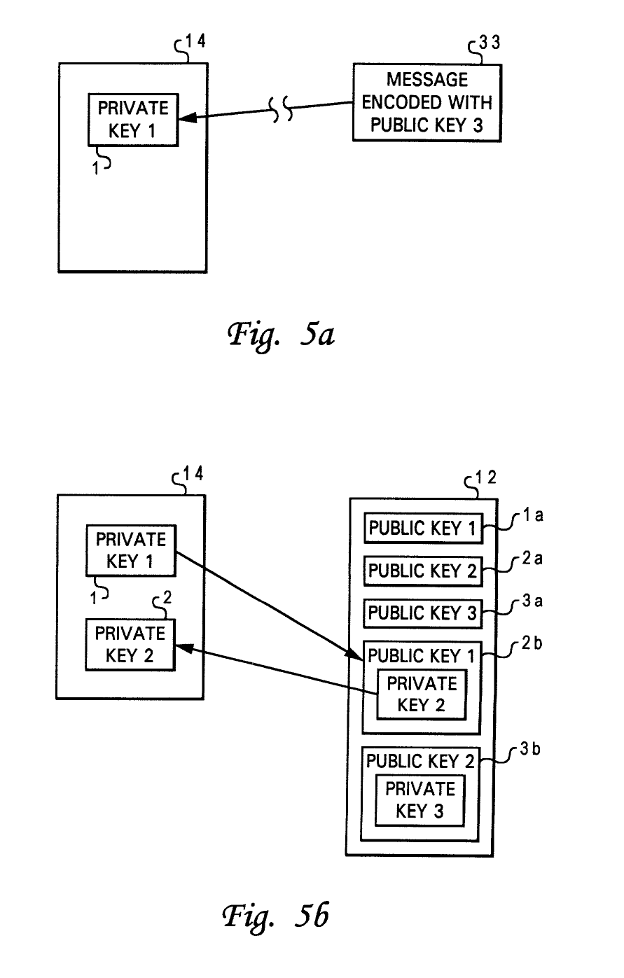

FIGS. 4a -4d illustrate a scenario in which TPM 14 does not have the necessary private key loaded to decode an incoming message. For example, as shown in FIG. 4a, assume that TPM 14 contains private key 2, but not private key 3. When an encoded message 33, encoded with public key 3, arrives at I/O 16, private key 2 is unable to decode it. Therefore, as shown in FIG. 4b, private key 2 first accesses a blob 3b in storage device 12. Blob 3b contains private key 3 surrounded by a security layer made up of public key 2a, which is the corresponding public key for private key 2.

Private key 2 unwraps blob 3b, by decoding and removing (“unwrapping”) the outer layer 20 made up of public key 2a, and stores private key 3 in TPM 14, as seen in FIG. 4c. Note that this “unwrapping” process takes place within TPM 14, such that private key 3 is never exposed outside TPM 14. As shown in FIG. 4d, TPM 14 now contains private key 3, which can decode encoded message 33, and send the decoded message to I/O 16 for proper handling.

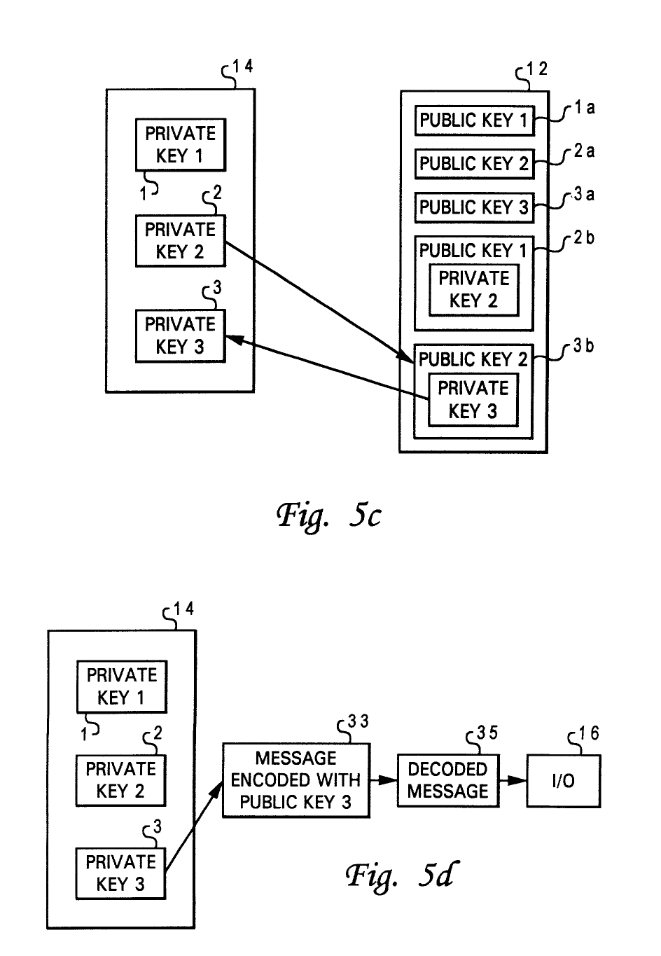

Often, an encoded message will arrive which needs to be decoded by a TPM private key 22 which cannot be immediately loaded. For example, in FIG. 5a, encoded message 33, which was encoded using public key 3, arrives at TPM 14 when TPM 14 is only loaded with private key 1. Private key 1 is the “grandfather” of private key 3. Private key 1 can only strip off the wrapping of a blob 2b stored in storage device 12, and does so as depicted in FIG. 5b. Private key 2 is now stored in TPM 14 along with private key 1. As shown in FIG. 5c, private key 2 can then unwrap the public key 2 from blob 3b, allowing private key 3 to be stored in TPM 14. As shown in FIG. 5d, private key 3 is then able to decode encoded message 33 into decoded message 35, and send decoded message 35 on to I/O 16. Thus FIG. 5 depicts a scenario in which two ancestral generations of private keys are necessary to load a needed private key into TPM 14.

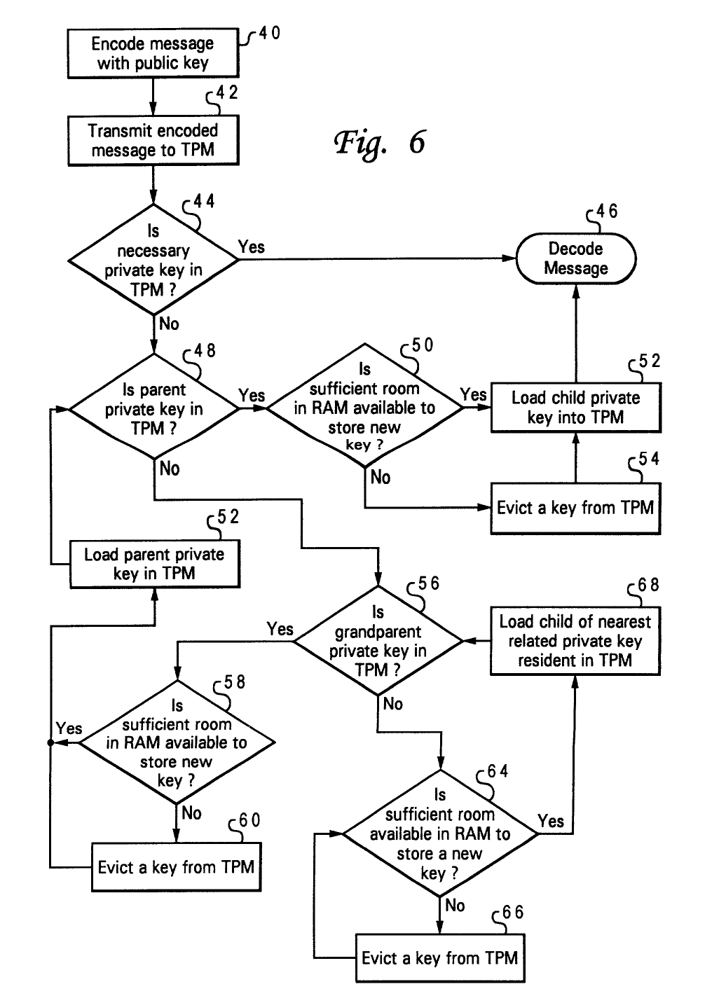

FIG. 6 is a flowchart depicting decoding of encoded messages using TPM 14. As shown in block 40, a public user first encodes a message using one of the public keys generated by TPM 14. The encoded message is then sent to TPM 14 as depicted in block 42. A query, illustrated in block 44, is made as to whether the private key necessary to decode the message is stored within TPM 14. If so, the message is decoded as depicted in terminal block 46. If the appropriate private key is not resident within TPM 14, a query, shown as block 48, is made as to whether the parent of the needed private key is stored in TPM 14. If the answer is yes, a query shown in block 50 is made as to whether sufficient room in TPM RAM 20 is available to store the needed TPM private key 22, which will be the child of the parent queried in block 48. If sufficient room in TPM RAM 20 is available, then the necessary private key 22 child will be loaded into TPM 14, as depicted in block 52, and the message decoded. If there is not sufficient room, room must first be made in TPM RAM 20 by evicting one of the existing TPM private keys 22, as illustrated in block 54.

Continuing with block 48, if the parent of the needed TPM private key 22 is not resident to TPM 14, then a query will be made as to whether the needed TPM private key 22's grandparent is in TPM 14, as illustrated in block 56. If the grandparent is residing in TPM 14, and sufficient room is available, the grandparent will then load the parent as depicted in blocks 58, 60, and 62. The parent will then load the child as described above, and the message is decoded. If the grandparent private key is not in TPM 14, then the child of whatever nearest related private key 22 resident in TPM 14 is loaded, and the process illustrated by blocks 56, 64, 66, and 68 continues until a grandparent of the needed private key 22 is loaded into TPM 14. Note that this child of root private key 24 is the highest TPM private key 22 that would ever need to be loaded, since the key hierarchally above that child is root private key 24, which is always stored in TPM 14.

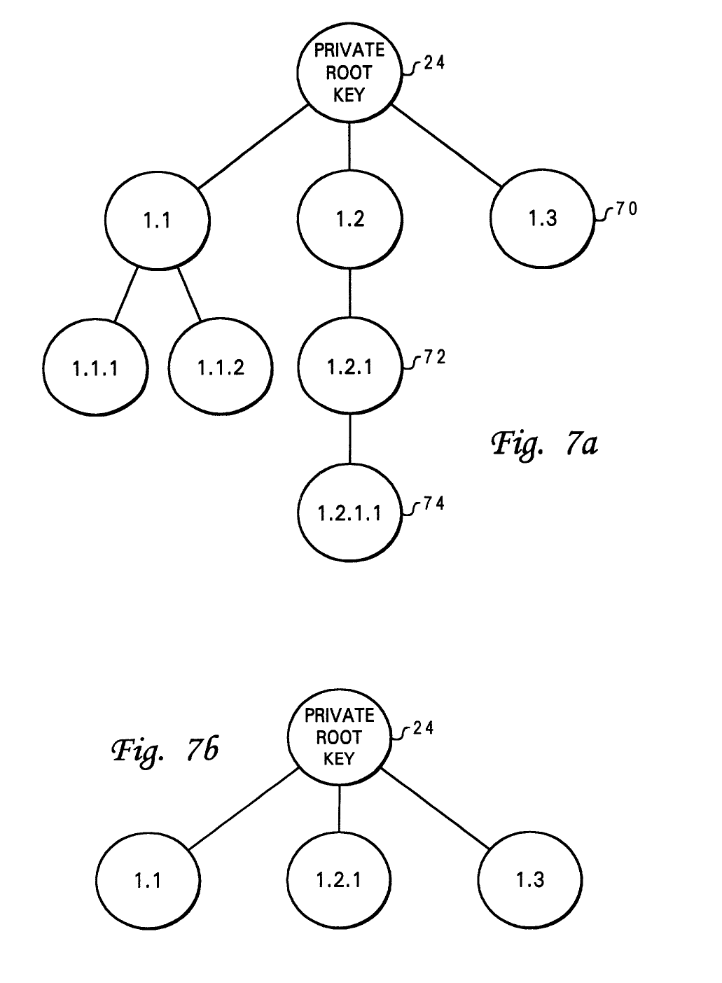

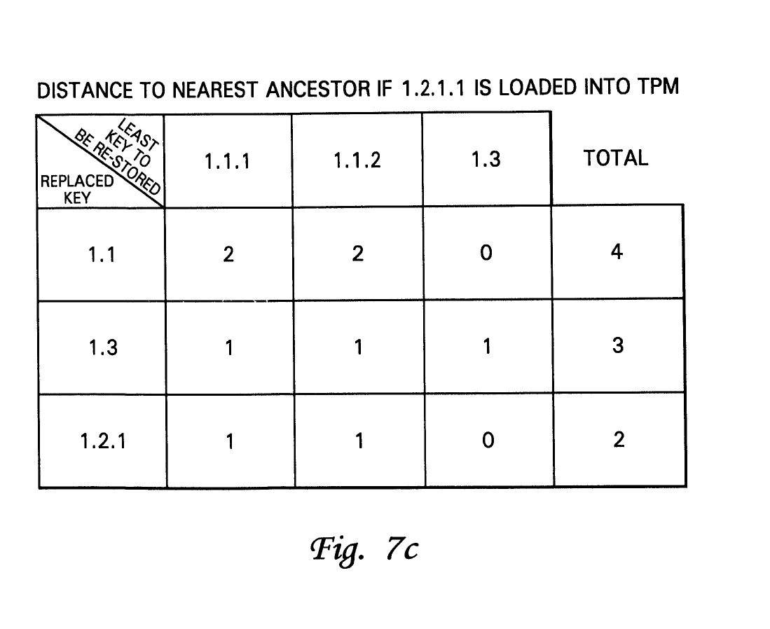

With reference now to FIG. 7a, there is depicted an exemplary TCPA hierarchal tree diagram of private keys, including the parent private root key 24 with its children 70, grandchildren 72, and great grandchildren 74. Each circle below private root key and illustrated in FIG. 7 depicts a cryptology private key. Within each cryptology private key is depicted a numerical indicator showing the lineage of that cryptology private key. For example, great grandchild 74 key 1.2.1.1 is the child of grandchild 72 key 1.2.1, which is the child of child 70 key 1.2, which is the child of parent private root key 24. Each key depicted that does not have a child is referred to as a “least key.” Only least keys are able to decode messages. The parents and other ancestors of each least key are called “storage keys,” and are only useful in unwrapping a key in order to store a private key in the TPM as described above. For example, the keys that are designated 1.1.1, 1.1.2, 1.2.1.1, and 1.3 are all least keys, while the remaining keys are storage keys.

TPM 14 (shown in FIG. 1) typically has a limited amount of TPM RAM. An exemplary TPM 14 will have sufficient TPM RAM to store four private keys, although other TPM's may have memory to hold an additional number of private keys. Referring now to FIG. 7b, assume for purposes of illustration that TPM 14 contains sufficient TPM RAM to hold four private keys. Assume that the hierarchy of keys and their associated private keys are those shown in FIG. 7a, having three children 70 keys (1.1, 1.2, and 1.3), three grandchildren 72 keys (1.1.1, 1.1.2, 1.2.1) and one great grandchild 74 key (1.2.1.1). Assume also that children 70 keys are all the children of parent root key 24, which as discussed above is always resident within TPM 14.

FIG. 7b illustrates three keys, 1.1, 1.2.1 and 1.3, which are stored in TPM 14's TPM RAM 20, and private root key 24, which is stored in TPM 14's TPM NVM 18, as depicted in FIG. 1 .

The table illustrated in FIG. 7c correlates to the hierarchy of keys illustrated in FIG. 7a and to those shown stored in FIG. 7b in TPM 14 as depicted in an exemplary form in FIG. 1. That is, TPM 14 has locally stored private keys 1.1, 1.3, and 1.2.1 plus private root key 24. Assume that private key 1.2.1.1 needs to be loaded into TPM RAM 20 to be used to decode a message. Since TPM RAM 20 only has sufficient memory for three evictable TPM private keys (non-root keys), one of the existing evictable TPM private keys 22 must be “evicted”.

The table shown in FIG. 7c assumes that private key 1.2.1.1 will be replacing one of the evictable keys shown in FIG. 7b as private keys 1.1, 1.3, or 1.2.1. A determination is then made as to what the impact will be when evicting one of these evictable private keys when another least key needs to be loaded in the future. Take, for example, the replacement of private key 1.1 with private key 1.2.1.1, as shown in the first row of the table depicted in FIG. 7c. If private key 1.1 is evicted to make room in TPM RAM 20 for private key 1.2.1.1, then if least key 1.1.1 needs to be loaded in the future, its storage private key 1.1 must first be loaded into TPM RAM 20 by root private key 24, after which least key 1.1.1 can then be loaded into TPM RAM 20. Restated, to load private key 1.1.1 in the future after evicting private key 1.1, private key 1.1 must first be re-stored in TPM RAM 20, followed by private key 1.1.1 being re-stored in TPM RAM 20. Thus there is a distance of two steps that must be taken to re-store private key 1.1.1. Likewise, there are two steps that will be necessary to re-store private key 1.1.2. There are no steps to re-store private key 1.3, since it was not evicted and is still in TPM RAM 20. The total steps that would be required to re-store each of the least private keys 1.1.1, 1.1.2, and 1.3 then are summed up. The number of steps is thus “four” if the storage key associated with key 1.1 is evicted. The same analysis is performed to determine the consequences of removing private key 1.3, and likewise for private key 1.2.1. Thus, it is apparent from FIG. 7c that removing private key 1.2.1, which would result in a total of only two possible generational steps for the other least private keys to be re-stored, will have the least impact in the future loading of least keys. Stated another way, there are only two total generation levels that may possibly need to be traversed to store all of the least keys shown in FIG. 7a.

Stating the above mathematically, where

Ki=each least TPM key

S=all private keys previously stored in the TPM RAM

Kj=evicted private TPM key

N=newly loaded private TPM key,

then the minimum impact on loading future TPM private keys is the minimum generational distance Dₘᵢₙ to the nearest storage key related to the replaced TPM private key, where

$${D}_{min} = {[ {\sum }_{I}^{i} D ( Ki , S - Kj + N ) ]}_{min}$$

The calculations shown in the above formula are analogous to those steps described above for FIG. 7c to determine which key is the least expensive to replace. Calculations based on the above formula are preferably performed by processor 10 depicted in FIG. 1. Processor 10 is able to perform calculations several orders of magnitude faster than the time that it takes to retrieve a blob from storage device 12 to load the requested TPM private key 22 in TPM RAM 20. Thus, there is no degradation in performance caused by these multiple calculations by processor 10.

Besides the expense associated with loading time caused by generational distances described above, the impact on TPM 14 is also a function of the probability of a least key needing to be loaded in the future. This probability can be stated mathematically where:

L=length of time since lease key Ki was last used

F=frequency of use of Ki over a predetermined amount of time

U=1 or 0, depending on whether a needed private key is already loaded in the TPM RAM, (value is 1 if “yes”), then

$$P ( Ki ) = \frac{A}{L} + B * F + C * V$$

where A, B, and C are constants. A, B and C are preferably determined by statistical sampling of the history of the TPM private keys 22 that have been requested and needed. Alternatively, A, B, and/or C may be determined by the user according to personal preferences. For example, any or all of the values A, B and C may be determinately set high to demonstrate that the user always wishes a particular private key 22 be loaded or easily or quickly loaded into TPM RAM 20.

In a preferred embodiment, a determination as to which TPM private key 22 is evicted, is determined by the combination of both the distance required to load a least key as first described above, as well as the probability that a least key will be needed as just described. Mathematically, this is depicted as

$${\sum }_{I}^{i} P ( Ki ) * D ( Ki , S - Kj + N )$$

The minimum value determined in the above equation will represent the least expensive route in CPU time for ejecting the identified TPM private key 22.

The above described method and system thus minimizes the expense in CPU time associated with loading private keys into TPM RAM 20 of TPM 14. In the environment described above, the key usage policy defined by this method would follow the user's profile. This policy could be freely accessible to the user, mapped to that user's profile based on experience or personal predefined preferences.

The present invention therefore affords an economical method and system of deciding which previously stored evictable cryptology key in the computer module should be evicted to allow room to store a new replacement cryptology key. The decision is based on the probability that the evicted cryptology key will be used by the computer module in the future, and thus need to be re-stored, and calculating the cycle time associated with re-storing the evicted cryptology key based on the remaining cryptology keys in the computer module. The future probability of use and amount of cycle time combine to define and determine the expense of evicting the evictable cryptology key. If one of the remaining cryptology keys is generationally close to the evicted cryptology key, such as a parent of the evicted cryptology key, then less cycle time will be required to re-store the evicted key than if the generationally closest remaining cryptology key is ancestrally more distant, such as a grandfather or great-grandfather. By evaluating both the likelihood of future use of the evicted key and the ancestral distance to a remaining key, the least expensive key can be identified for eviction and replacement by the replacement cryptology key.

It should further be appreciated that the method described above for replacing a cryptology key can be embodied in a computer program product in a variety of forms, and that the present invention applies equally regardless of the particular type of signal bearing media utilized to actually carry out the method described in the invention. Examples of signal bearing media include, without limitation, recordable type media such as floppy disks or compact disk read only memories (CD ROMS) and transmission type media such as analog or digital communication links.

While the invention has been particularly shown and described with reference to a preferred embodiment, it will be understood by those skilled in the art that various changes in form and detail may be made therein without departing from the spirit and scope of the invention. For example, while the methodology for determining which private key to evict has been described in a TPM environment, the same procedure is useful in any similar environment using a hierarchical key structure.

What is claimed is:

1. A method for replacing a cryptology key in a computer module, wherein said computer module includes a plurality of evictable cryptology keys, said method comprising:
determining, for each of a plurality of evictable cryptology keys in a computer module, a replacement expense for each said evictable cryptology key, said replacement expense determined by:
a probability that each said evictable cryptology key will be needed by the computer module after said evictable cryptology key is evicted, and an amount of cycle time required to re-store, if evicted, each said evictable cryptology key in the computer module;
identifying a least expensive evictable cryptology key based on said replacement expense; and
replacing said least expensive evictable cryptology key with a replacement cryptology key.

2. The method of claim 1, said step of replacing said least expensive cryptology key further comprising:
locating a blob comprising said least expensive evictable cryptology key and a security software shell;
removing said security software shell from said blob; and
storing said least expensive evictable cryptology key in said computer module.

3. The method of claim 1 further comprising:
determining said cycle time by calculating a number of generations to a nearest ancestor of said least expensive evictable cryptology key, said nearest ancestor being from a plurality of non-evicted remaining cryptology keys in the computer module.

4. The method of claim 3 further comprising:
storing, if a parent cryptology key of said least expensive evictable cryptology key is not stored in said computer module, a child cryptology key of said nearest ancestor key of said least expensive evictable cryptology key; and
repeating said storing step until said least expensive evictable cryptology key is stored in said computer module.

5. The method of claim 1, wherein the computer module is a Trusted Platform Module (TPM).

6. A data-processing system capable of replacing a cryptology key in a computer module, wherein said computer module includes a plurality of evictable cryptology keys, said data-processing system comprising:
means for determining, for each of a plurality of evictable cryptology keys in a computer module, a replacement expense for each said evictable cryptology key, said replacement expense determined by:
a probability that each said evictable cryptology key will be needed by the computer module after said evictable cryptology key is evicted, and an amount of cycle time required to re-store, if evicted, each said evictable cryptology key in the computer module;
means for identifying a least expensive evictable cryptology key based on said replacement expense; and
means for replacing said least expensive evictable cryptology key with a replacement cryptology key.

7. The data processing system of claim 6, said means for replacing said least expensive cryptology key further comprising:
means for locating a blob comprising said least expensive evictable cryptology key and a security software shell;
means for removing said security software shell from said blob; and
means for storing said least expensive evictable cryptology key in said computer module.

8. The data processing system of claim 6 further comprising:
means for determining said cycle time by calculating a number of generations to a nearest ancestor of said least expensive evictable cryptology key, said nearest ancestor being from a plurality of non-evicted remaining cryptology keys in the computer module.

9. The data processing system of claim 8 further comprising:
means for storing, if a parent cryptology key of said least expensive evictable cryptology key is not stored in said computer module, a child cryptology key of said nearest ancestor key of said least expensive evictable cryptology key; and
means for repeating said storing step until said least expensive evictable cryptology key is stored in said computer module.

10. The data processing system of claim 6, wherein the computer module is a Trusted Platform Module (TPM).

11. A computer usable medium for replacing a cryptology key in a computer module, wherein said computer module includes a plurality of evictable cryptology keys, said computer usable medium comprising:
computer program code for determining, for each of a plurality of evictable cryptology keys in a computer module, a replacement expense for each said evictable cryptology key, said replacement expense determined by:
a probability that each said evictable cryptology key will be needed by the computer module after said evictable cryptology key is evicted, and an amount of cycle time required to re-store, if evicted, each said evictable cryptology key in the computer module;
computer program code for identifying a least expensive evictable cryptology key based on said replacement expense; and
computer program code for replacing said least expensive evictable cryptology key with a replacement cryptology key.

12. The computer usable medium of claim 11, said computer program code for replacing said least expensive cryptology key further comprising:
computer program code for locating a blob comprising said least expensive evictable cryptology key and a security software shell;
computer program code for removing said security software shell from said blob; and
computer program code storing said least expensive evictable cryptology key in said computer module.

13. The computer usable medium of claim 11 further comprising:
computer program code for determining said cycle time by calculating a number of generations to a nearest ancestor of said least expensive evictable cryptology key, said nearest ancestor being from a plurality of non-evicted remaining cryptology keys in the computer module.

14. The computer usable medium of claim 13 further comprising:
computer program code for storing, if a parent cryptology key of said least expensive evictable cryptology key is not stored in said computer module, a child cryptology key of said nearest ancestor key of said least expensive evictable cryptology key; and
computer program code for repeating said storing step until said least expensive evictable cryptology key is stored in said computer module.

15. The computer usable medium of claim 11, wherein the computer module is a Trusted Platform Module (TPM).
